(19) United States
(12) Patent Application Publication
(10) Pub. No.: US 2024/0380732 A1
(43) Pub. Date: Nov. 14, 2024

(54) SYSTEM FOR CONTROLLING NETWORK ACCESS OF APPLICATION ON BASIS OF TCP SESSION CONTROL, AND METHOD RELATED THERETO

(71) Applicant: PRIBIT Technology, Inc., Seoul (KR)

(72) Inventor: Young Rang KIM, Seoul (KR)

(21) Appl. No.: 18/688,304

(22) PCT Filed: Sep. 2, 2022
(86) PCT No.: PCT/KR2022/013193

§ 371 Date: Feb. 29, 2024

(30) Foreign Application Priority Data
Sep. 3, 2021 (KR) 10-2021-0117398

(51) Int. Cl. H04L 9/40

(52) U.S. Cl. CPC H04L 63/0236

(57) ABSTRACT

According to an embodiment disclosed in the specification, a network node may include a communication circuit, a memory, and a processor operatively connected to the communication circuit and the memory. The processor may receive, from a server, a data flow including a node IP, a destination network IP, and port information, which are created to allow creation of a TCP session between a source node and a destination network, may monitor a data packet broadcast or multicast from the source node at a network boundary, may transmit an IP blocking data packet to the source node when there is no data flow corresponding to a source IP of the data packet received through the monitoring, or may transmit a TCP data packet for forcibly terminating a TCP session to the source node when there is no data flow corresponding to a destination IP and destination port information of the data packet received through the monitoring.

### CROSS-REFERENCE TO RELATED APPLICATION

This application claims the benefit of priority to Korean Patent Application No. 10-2021-0117398, filed in the Korean Intellectual Property Office on Sep. 3, 2021, the entire contents of which are incorporated herein by reference.

### TECHNICAL FIELD

Embodiments disclosed in the specification relate to a system for controlling network access of an application based on TCP session control, and a method therefor.

### BACKGROUND ART

In general, communication between a terminal and a server uses an Internet protocol (IP)-based transmission control protocol (TCP). A firewall technology that performs access control by identifying a source IP, a destination IP, and port information by using 5-tuple information included in a data packet is commonly used.

The firewall technology may block unauthorized IPs from accessing unauthorized destination networks by identifying IP assigned to a terminal or network node (e.g., a switch, a router, etc.) and performing access control for inbound or outbound data packets between network boundaries.

When a private IP band is created by configuring a sub-network using a terminal, a router, or a switch in an Internet band where IP allocation and control are difficult, it is difficult to control on an IP basis in technologies such as IP-based firewalls. IP may be forged or altered due to the IP communication structure, and thus firewalls are substantially used as a minimum security device.

To this end, data packets transmitted between the terminal and the server or switches are encrypted or are not forged or altered. Issues with firewalls are solved by using connectivity control technologies, which allow unique access only to authorized targets, such as tunneling technologies (e.g. IPSec, GRE, GTP, etc.) or secure sessions (secure sockets Layer or transport layer security).

As an example of a tunneling technology, referring to FIG. 1, a source node 101 between a first network 10 and a second network 20 that are different from each other may attempt to access the second network 20. When the source node 101 transmits data to a destination node 102 included in the second network 20, the source node 101 may transmit data to the destination node 102 through a switch 103 and a tunnel 105.

### DISCLOSURE

### Technical Problem

However, when a connectivity control technology is used, well-known tunneling or secure session technologies need to be used. Accordingly, due to applications that communicate according to encryption protocols, sections where encryption is not necessary, or network environment problems, it is difficult to use the tunneling technology.

Furthermore, one or more switches need to be present at a network boundary between a terminal and a server. When a serious failure occurs in the switch because all data packets pass through the corresponding switch, all data packets reaching the server or destination network are blocked, and thus communication failure occurs.

As a result, the connectivity control technology that does not use tunneling or secure session technologies is required in a special network environment (e.g., an environment where access control is required in units of detailed network present in the same segment as the terminal) where security and stability need to be compromised. A representative example of a technology that performs access control using an IP communication mechanism in such a network environment is a network access control (NAC) technology.

To transmit data packets from the terminal to the destination, the IP communication mechanism identifies a physical address (media access control (MAC) address) based on the IP of the destination by using an address resolution protocol (ARP), which is an address resolution protocol, and then transmits the data packets to the corresponding MAC Address.

The NAC that is present in the same segment as the terminal receives the data packet. When an unauthorized terminal attempts access, the NAC informs the terminal of the MAC Address of the NAC through ARP spoofing. Accordingly, a structure is provided to block data packets from being transmitted to the actual communication target.

The NAC technology refers to a technology for blocking the IP of terminals that have not been authenticated or authorized in advance. The NAC technology is designed to prevent unauthorized terminals (e.g., terminals brought in from outside or terminals not permitted) connected to an intranet network from accessing servers and business resources. However, the NAC technology blocks the access based on unauthorized source IPs, thereby making it difficult to control fine-grained network access.

In other words, the NAC may control network access based on the IP assigned to the terminal. However, because the NAC does not perform access control at a level of an application, which is the subject actually performing communication, when an IP is assigned to a terminal, and access is allowed by the NAC, ransomware or malware included in the terminal brought in from outside may access all resources on the corresponding network. Accordingly, the NAC may spread and infect the ransomware or malware.

To solve connectivity control problems in special network environments through TCP-based connectivity control technologies, not tunneling or secure session-based connectivity control technologies, various embodiments disclosed in the specification provide a method of accessing only authorized networks based on information about an access target application, information about a terminal executing the application, or one or more identification information, and a method of preventing unauthorized subjects from creating TCP sessions and releasing network access to invalid targets in situations such as risk detection or termination of applications and services.

### Technical Solution

According to an embodiment disclosed in the specification, a network node may include a communication circuit, a memory, and a processor operatively connected to the communication circuit and the memory. The processor may receive, from a server, a data flow including a node IP, a destination network IP, and port information, which are created to allow creation of a TCP session between a source node and a destination network, may monitor a data packet broadcast or multicast from the source node at a network boundary, may transmit an IP blocking data packet to the source node when there is no data flow corresponding to a source IP of the data packet received through the monitoring, or may transmit a TCP data packet for forcibly terminating a TCP session to the source node when there is no data flow corresponding to a destination IP and destination port information of the data packet received through the monitoring.

According to an embodiment, the processor may prevent an access control application of the source node from transmitting a data packet to a destination network by removing a data flow, when a data flow removal request is received from the server.

According to an embodiment, the processor may transmit a collected data packet blocking log to the server at regular intervals in response to detecting a data packet blocking log update event for data packet blocking log synchronization.

According to an embodiment, the data packet blocking log update event may include IP blocking or forcedly terminating the TCP session, and the data packet blocking log may include a node IP address, a destination IP address, and port information, which are blocked.

According to an embodiment disclosed in the specification, a server may include a communication circuit, a memory that stores a database, and a processor operatively connected to the communication circuit and the memory. The processor may receive a request for network access from an access control application of a source node, may determine whether identification information including an application, a destination network IP, and service port information are included in an access policy matched with information identified on a control flow including the source node, a user, and network information of the source node, and whether access to a destination network mapped with the identification information is possible, may identify a network node where the source node is located in a network node policy to allow access of the source node, when access is possible, may determine whether data flow information accessible by using the destination network IP and the service port information is present in a data flow table, may create data flow information based on an IP of the source node, the destination network IP, and the service port information such that the application is capable of creating a TCP session with the destination network, when there is no valid data flow information in the data flow table, and transmit the created data flow information to the source node and the identified network node, may transmit the data flow information to the source node when the accessible data flow information is present in the data flow table, may receive a data packet blocking log from the network node, and may update a blacklist based on the data packet blocking log and a blacklist policy included in the database.

According to an embodiment, the processor may receive a request for user authentication from the access control application of the source node, may determine whether the user is blocked, by checking whether the user is accessible, based on information requested for authentication by the access control application, and whether the user is included in a blacklist, may search for a control flow in a control flow table by using control flow identification information when the user is identified to being the accessible user, and add user identification information to identification information in the found control flow, and may return an authentication completion status and access policy information of an authenticated user to the source node as a result of user authentication.

According to an embodiment, the processor may create accessible application whitelist information in an access policy matched with the identified information, may return an access completion status as an access result, and may return control flow identification information for identifying a control flow, and the created application whitelist, when an additional user authentication request of the source node or a continuous terminal information update request is received.

According to an embodiment, the processor may receive a control flow update request from the source node, may determine whether a control flow is present in the control flow table, based on control flow identification information requested by the source node in response to the control flow update request, may return inaccessibility information indicating that access of the source node is invalid, to the source node when there is no control flow for the source node in the control flow table, may update an update time when there is a control flow for the source node in the control flow table, and search for data flow information dependent on the control flow, may return data flow information to the source node when authentication needs to be again performed on a data flow for the source node or there is a data flow incapable of being accessed, and may update information of the data flow table when a control flow update result is normal, and there is updated data flow information.

According to an embodiment, the processor may receive a control flow termination request from the source node, may remove a control flow identified and found based on control flow identification information, which is requested by the source node, in response to a control flow termination request, and may transmit a data flow removal request to the network node and request removal when the control flow is removed. The network node may prevent the access control application from transmitting a data packet to a destination network by removing a data flow in response to the data flow removal request.

According to an embodiment disclosed in the specification, an operating method of a network node may include receiving, from a server, a data flow including a node IP, a destination network IP, and port information, which are created to allow creation of a TCP session between a source node and a destination network, monitoring a data packet broadcast or multicast from the source node at a network boundary, transmitting an IP blocking data packet to the source node when there is no data flow corresponding to a source IP of the data packet received through the monitoring, and transmitting a TCP data packet for forcibly terminating a TCP session to the source node when there is no data flow corresponding to a destination IP and destination port information of the data packet received through the monitoring.

### Advantageous Effects

According to embodiments disclosed in the specification, an access application may receive data flow information (source IP and destination IP, or port information) for allowing the transmission of data packets from a controller based on IP assigned to a terminal through identifying and authenticating the terminal, one or more identification information, and applications, and IP of the terminal identified by the controller, to access a service server. The data flow may be simultaneously propagated to a protector placed at a network boundary.

According to embodiments disclosed in the specification, an access control application primarily may allow or block transmission of the access application's network access depending on the data flow information received from the controller. When data packets are transmitted by bypassing the access control application, or there is no data flow received from the controller in the protector placed at the network boundary, the TCP session is forcibly terminated. Accordingly, according to the embodiments disclosed in the specification, the access control application may fundamentally block unauthorized targets from accessing unauthorized service servers using TCP.

According to embodiments disclosed in the specification, because unauthorized terminals and applications, and unsafe applications are fundamentally blocked from accessing unauthorized networks, ransomware and malware (in particular, new risk factors that have not been detected by antivirus, vaccine, or malware detection tools) included in terminals brought in from outside may be blocked from spreading and attacking the connected network or service server.

Because the network access is controlled by using commonly used TCP-based communication, not conventional tunneling or secure session-based connectivity control, it is possible to control access by separating authorized and unauthorized targets from each other without modifying the existing application, which is sensitive to its own communication protocol or performance.

According to embodiments disclosed in the specification, the protector may indirectly collect and monitor data packets generated on the switch connected to the terminal or on the same network segment. When continuous access attempts by an unauthorized target or unauthorized network access attempts by an authorized target are repeated, the protector may determine potential risk factors and may permanently block the access of the corresponding terminal and application through releasing data flow information and releasing control flow information.

Moreover, like conventional network security technologies, the protector is not directly connected to the network between the terminal and the service server. Instead, the protector indirectly controls network access by utilizing the characteristics of the IP network. Consequently, degraded network performance and network failures may be mitigated.

In particular, the controller may monitor the transmission time of data packets exchanged between the application and the service server. When there is no data packet transmission or reception for a certain period of time, there is no continuous access update between the application and the controller, the application has been terminated, or network access needs to be blocked based on information identified through the service server linked to the controller or linked to other security systems, the controller may immediately release control flow and data flow and may provide a blocking method at a network level such that the corresponding to transmission subject is incapable of accessing the service server. Therefore, accurate release for ambiguous network access release time points between the application and the service server, and life cycle management may be possible.

According to embodiments disclosed in the specification, when important functions or security functions included in the application are not executed sequentially or access is made by bypassing a specific function in a state where the application has been forged or altered, a method of blocking access to all networks may be provided. Because an application forged or altered in a state where network access is fundamentally blocked does not perform any attack actions, a method of fundamentally solving issues of bypassing important security functions and causing dangerous actions to the service server may be provided.

Furthermore, a complete blocking method is provided in the network by retrieving all pieces of data flow information when network access is no longer required. Consequently, a complete isolation method may be provided.

As a result, a secure network connection life cycle ranging from application network access control, threat blocking, and isolation may be implemented by using TCP session-based connectivity control technologies, and a secure network connection that eliminates issues inherent in existing IP communications may be provided.

Besides, a variety of effects directly or indirectly understood through the present disclosure may be provided.

### DESCRIPTION OF DRAWINGS

FIG. 1 shows an example of a tunneling technology.

FIG. 2 illustrates architecture in a network environment, according to various embodiments.

FIG. 3 is a functional block diagram illustrating a database stored in a controller, according to various embodiments.

FIG. 4 is a functional block diagram of a node, according to various embodiments.

FIG. 5 is a diagram for describing an operation in which network access is blocked, according to various embodiments.

FIG. 6 shows a signal flow diagram for accessing a controller, according to various embodiments.

FIG. 7 shows a user interface screen for accessing a controller, according to various embodiments.

FIG. 8 shows a signal flowchart for user authentication, according to various embodiments.

FIG. 9 illustrates a flowchart of a signal for processing network access.

FIG. 10 shows a signal flowchart for blocking network access, according to various embodiments.

FIG. 11 shows a flowchart for updating a control flow, according to various embodiments.

FIG. 12 illustrates a flowchart for releasing network access, according to various embodiments.

FIG. 13 shows a flowchart for releasing unit network access, according to various embodiments.

FIG. 14 shows a flowchart for synchronization of data packet blocking logs, according to various embodiments.

FIG. 15 shows a flowchart for terminating application execution, according to various embodiments.

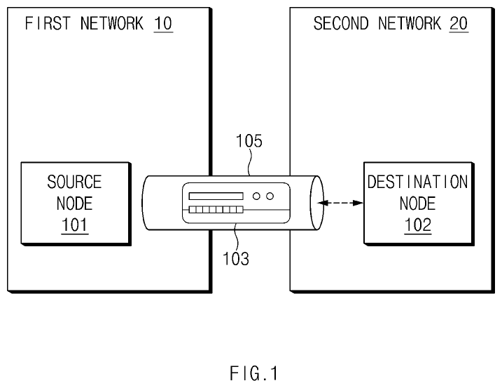

### MODE FOR INVENTION

Hereinafter, various embodiments of the present disclosure may be described with reference to accompanying drawings. However, it should be understood that this is not intended to limit the disclosure to specific implementation forms and includes various modifications, equivalents, and/or alternatives of embodiments of the disclosure.

In this specification, the singular form of the noun corresponding to an item may include one or more of items, unless interpreted otherwise in context. In the disclosure, the expressions “A or B”, “at least one of A and B”, “at least one of A or B”, “A, B, or C”, “at least one of A, B, and C”, and “at least one of A, B, or C” may include any and all combinations of one or more of the associated listed items. The terms, such as “first” or “second” may be used to simply distinguish the corresponding component from the other component, but do not limit the corresponding components in other aspects (e.g., importance or order). When a component (e.g., a first component) is referred to as being “coupled with/to” or “connected to” another component (e.g., a second component) with or without the term of “operatively” or “communicatively”, it may mean that a component is connectable to the other component, directly (e.g., by wire), wirelessly, or through the third component.

Each component (e.g., a module or a program) of components described in this specification may include a single entity or a plurality of entities. According to various embodiments, one or more components of the corresponding components or operations may be omitted, or one or more other components or operations may be added. Alternatively or additionally, a plurality of components (e.g., a module or a program) may be integrated into one component. In this case, the integrated component may perform one or more functions of each component of the plurality of components in the manner same as or similar to being performed by the corresponding component of the plurality of components prior to the integration. According to various embodiments, operations executed by modules, programs, or other components may be executed by a successive method, a parallel method, a repeated method, or a heuristic method. Alternatively, at least one or more of the operations may be executed in another order or may be omitted, or one or more operations may be added.

The term “module” used herein may include a unit, which is implemented with hardware, software, or firmware, and may be interchangeably used with the terms “logic”, “logical block”, “part”, or “circuit”. The “module” may be a minimum unit of an integrated part or may be a minimum unit of the part for performing one or more functions or a part thereof. For example, according to an embodiment, the module may be implemented in the form of an application-specific integrated circuit (ASIC).

Various embodiments of the present disclosure may be implemented with software (e.g., a program or an application) including one or more instructions stored in a storage medium (e.g., a memory) readable by a machine. For example, the processor of a machine may call at least one instruction of the stored one or more instructions from a storage medium and then may execute the at least one instruction. This enables the machine to operate to perform at least one function depending on the called at least one instruction. The one or more instructions may include a code generated by a complier or a code executable by an interpreter. The machine-readable storage medium may be provided in the form of a non-transitory storage medium. Herein, ‘non-transitory’ just means that the storage medium is a tangible device and does not include a signal (e.g., electromagnetic waves), and this term does not distinguish between the case where data is semipermanently stored in the storage medium and the case where the data is stored temporarily.

A method according to various embodiments disclosed in the specification may be provided to be included in a computer program product. The computer program product may be traded between a seller and a buyer as a product. The computer program product may be distributed in the form of a machine-readable storage medium (e.g., compact disc read only memory (CD-ROM)) or may be distributed (e.g., downloaded or uploaded), through an application store, directly between two user devices (e.g., smartphones), or online. In the case of on-line distribution, at least part of the computer program product may be at least temporarily stored in the machine-readable storage medium such as the memory of a manufacturer's server, an application store's server, or a relay server or may be generated temporarily.

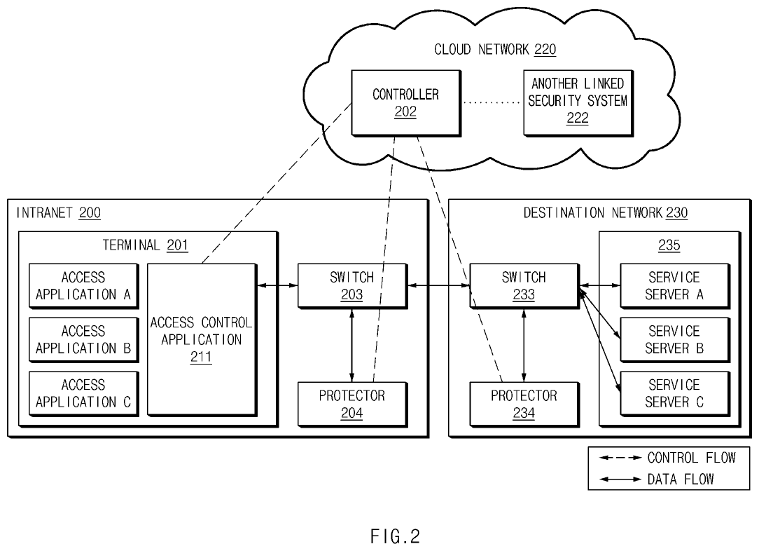

FIG. 2 illustrates architecture in a network environment, according to various embodiments.

Referring to FIG. 2, the number of terminals 201, the number of switches 203, and the number of protectors 204 are not limited to the number shown in FIG. 2. FIG. 2 is an example of a TCP-based connectivity control technology.

The TCP-based connectivity control technology may provide a structure in which only an authenticated application based on an IP (private IP or public IP) assigned to the terminal 201 or the IP (public IP) identified by a controller 202 creates and maintains a TCP session with a service server 235 such that the application accesses the service server 235, and the TCP session of the unauthorized terminal 201 or an unauthorized application is terminated by the protector 204, making it impossible to continuously maintain communication. The protector 204 may also be referred to as a ‘network node’.

When network access occurs, the terminal 201 may determine whether access is possible from the controller 202. Only when the network access is possible, the terminal 201 may transmit a data packet to the switch 203 located at the border of an access target network through data flow information generated by the controller 202. The terminal 201 may be located within an intranet 200. The intranet 200 may include the terminal 201, the switch 203, and the protector 204. In the intranet 200, the terminal 201 and the switch 203 may be operatively connected to each other, and the switch 203 and the protector 204 may be operatively connected to each other.

An access control application 211 determines whether access is possible from the controller 202, before communicating with the service server 235. Only when the network access is possible, data packets are transmitted to a network through the access control application. When the received TCP data packet is not included in data flow information (authorized source IP, destination IP, or port) received from the controller 202, the protector 204 receiving IP-based multicast information on each network boundary prevents unauthorized applications from continuously communicating with the service server 235 by propagating a data packet that terminates the corresponding TCP session.

According to various embodiments, the terminal 201 may include the access control application 211, which manages network access of an application stored in the terminal 201, and a network driver (not shown). For example, the access control application may control the transmission of a data packet through a kernel including an operating system and the network driver within the terminal 201.

For example, the controller 202 may be a server (or a cloud server). The controller 202 may guarantee reliable data transmission in a network environment by managing data transmission between the terminal 201, the protector 204, and a destination network 230. The controller 202 provides a method of always maintaining a safe network state such as removal and release of the created data flow, isolation of the terminal 201 through a blacklist, or the like depending on control network access of an application, a policy for controlling TCP access in a network to which the terminal 201 and the protector 204 belong, a state of unauthorized access received from the protector 204, or an security event received from a service server and an interlocking system. In the meantime, the controller 202 may include a server or an external server. The controller 202 may be located within a cloud network 220, and the controller 202 may be operatively connected to other linked security systems 222.

The protector 204 may be present on a network boundary basis. The protector 204 may identify the IP of the terminal 201 through network address translation (NAT) depending on a network band through the controller 202, may receive data flow information optimized for IP (source IP) of the terminal 201, on which NAT is performed for each border, and may control access.

An administrator may access the controller 202 and may configure a TCP connection-centered policy to control access between the application and the server. Accordingly, detailed and safe control in a network access perspective is possible compared to existing network security technologies simply performing IP access control.

When receiving a data packet transmitted from a network segment such as the switch 203 or the terminal 201, the protector 204 may determine whether the data packet present in the data flow has been received.

The data flow information received from the controller 202 may include source IP, destination IP, and port information. In case of a data packet where a data flow is not present, the unauthorized terminal 201 and the application may be blocked from accessing an unauthorized server and maintaining the access by transmitting the data packet (e.g., RST) for terminating the TCP session to the source IP.

The unauthorized terminal 201 continuously attempts to create and connect a TCP session. However, the TCP session is forcibly terminated through the TCP session control procedure, and thus actual network access and communication are impossible.

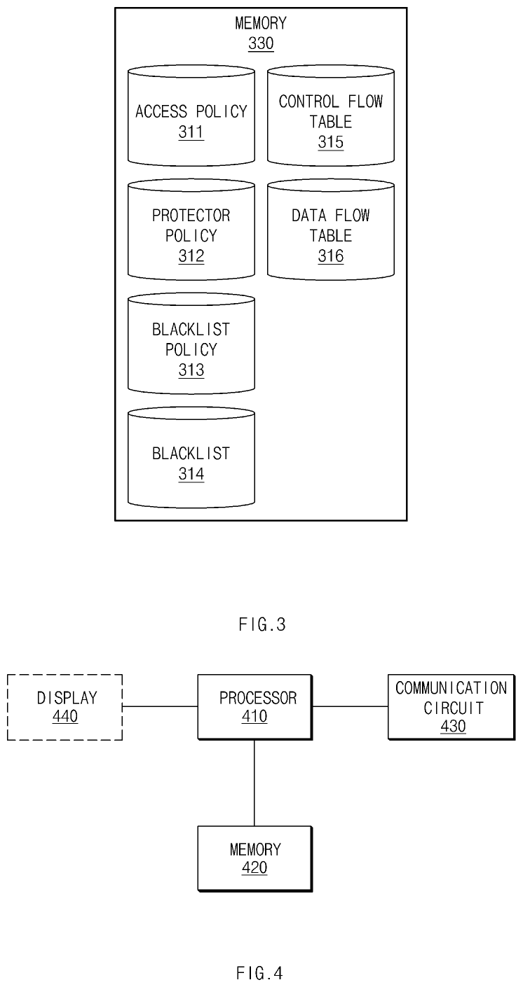

FIG. 3 is a functional block diagram illustrating a database stored in a controller (e.g., the controller 202 of FIG. 2), according to various embodiments. FIG. 3 illustrates only a memory 330. However, the controller 202 may further include a communication circuit (e.g., a communication circuit 430 of FIG. 4) for communicating with an external electronic device (e.g., the terminal 201, the switch 203 or the destination network 230 in FIG. 2) and a processor (e.g., a processor 410 of FIG. 4) for controlling overall operations of the controller.

Referring to FIG. 3, the controller may store, in the memory 330, databases 311 to 316 for controlling network access and data transmission.

The access policy database 311 may include information about the terminal 201 to be accessed, one or more identification information, or service information capable of being accessed by an application. When the application requests network access, it may be determined whether the terminal 201, one or more identified targets, or applications identified based on the corresponding policy are capable of accessing a service.

The protector policy database 312 may include information about a protector placed between network boundaries of a service server (destination IP and port) on a connection path, network band information to be managed by the protector for a source node (the terminal 201) to access the service server, and expiration time information for periodically updating a data flow.

The blacklist policy database 313 may be used to set a blacklist registration policy for permanently or temporarily blocking the identified target from being accessed based on information (information about the terminal 201, one or more identification information, IP address, MAC address, or information about users) identified through a risk, a period, and behavior analysis of a security event among security events collected periodically from the terminal 201 or the protector 204.

The blacklist database 314 may include information about the terminal 201 whose access is blocked according to the blacklist policy database 313, one or more identification information, IP, MAC address, or information about users. When the identified information is included in the corresponding list at a point in time when the controller 202 requests access, the access request is denied, and thus the application is completely isolated because network access is impossible.

The control flow table 315 may be a type of session table for managing a flow created between the application and the controller 202. When the application successfully accesses the controller 202, identification information is created to identify a control flow and a control flow. The control flow includes an IP address identified during access and authentication of the controller 202, information about the terminal 201, one or more identification information, application identification information, or information additionally identified through association with the service server 235.

Control flow identification information transmitted when the application requests network access and respective identification information included in the control flow found by using the corresponding identification information are mapped to an access policy. Accordingly, the mapped result is used as information about whether access to the service server 235 is possible, and whether a data flow is capable of being created to create a TCP session with the service server 235.

The application needs to periodically update the expiration time of the control flow. When the update is not made for a certain period of time, a control flow is removed. The control flow is removed depending on a case that immediate access blocking is required depending on a risk level of a security event collected from an access application, another security application, and the protector 204, or an access termination request of the application.

When the control flow is removed, all related data flows are retrieved. All pieces of access are blocked through the protector 204 placed between the application and the service server 235.

The data flow table 316 refers to a table in which the terminal 201 and the protector 204 placed between the terminal 201 and the service server 235 manage a flow where detailed data packets are transmitted. The data flow table 316 includes data flow information for managing a TCP session created in units of service of the application of the source terminal 201 and the server.

The TCP session with one or more services may be created by using data flow identification information for identifying the data flow, information about the respective terminal 201, one or more identification information, and an application, and dependent data flows may be managed by using the control flow identification information assigned to a transmission subject. Authorized target information required for the protector 204 placed between the application and the service server 235 to determine whether to transmit and release a TCP session termination data packet based on the source IP, destination IP, and service port information of the corresponding data packet, and authentication expiration time information required when the corresponding data flow is periodically authenticated may be included.

Moreover, the structure of the data flow table 316 included in the controller 202 may be applied identically or similarly to the terminal 201 and the protector 204.

FIG. 4 shows a functional block diagram of a node (e.g., the terminal 201 and the destination network 230 in FIG. 2), according to various embodiments. Referring to FIG. 4, a node may be the terminal 201, and may include a processor 410, a memory 420, and a communication circuit 430. According to an embodiment, the node may further include a display 440 for interfacing with a user.

The processor 410 may control overall operations of the terminal 201. In various embodiments, the processor 410 may include a single processor core or may include a plurality of processor cores. For example, the processor 410 may include a multi-core such as a dual-core, a quad-core, a hexa-core, or the like. According to embodiments, the processor 410 may further include a cache memory positioned inside or outside the processor 410. According to embodiments, the processor 410 may be configured with one or more processors. For example, the processor 410 may include at least one of an application processor, a communication processor, or a graphical processing unit (GPU).

All or part of the processor 410 may be electrically or operatively coupled with or connected to another component (e.g., the memory 420, the communication circuit 430, or the display 440) within the node. The processor 410 may receive a command from other components of the node, may interpret the received command, and may perform calculations or process data depending on the interpreted command. The processor 410 may interpret and process messages, data, instructions, or signals received from the memory 420, the communication circuit 430, or the display 440. The processor 410 may generate new messages, data, instructions, or signals based on the received messages, data, instructions, or signals. The processor 410 may provide the processed or generated messages, data, instructions, or signals to the memory 420, the communication circuit 430, or the display 440.

The processor 410 may process data or signals, which is generated by a program and occurs in a program. For example, the processor 410 may request instructions, data, or signals from the memory 420 to execute or control a program. The processor 410 may write (or store) or update instructions, data, or signals to the memory 420 to execute or control the program.

The memory 420 may store instructions for controlling the node, control command codes, control data, or user data. For example, the memory 420 may include at least one of an application program, an operating system (OS) (e.g., Microsoft Windows, Google Android, Apple IOS, MacOS, or the like), middleware, or a device driver.

The memory 420 may include one or more of a volatile memory or a non-volatile memory. The volatile memory may include a dynamic random access memory (DRAM), a static RAM (SRAM), a synchronous DRAM (SDRAM), a phase-change RAM (PRAM), a magnetic RAM (MRAM), a resistive RAM (RRAM), a ferroelectric RAM (FeRAM), and the like. The non-volatile memory may include a read only memory (ROM), a programmable ROM (PROM), an electrically programmable ROM (EPROM), an electrically erasable programmable ROM (EEPROM), a flash memory, and the like. The memory 420 may further include nonvolatile media (medium) such as a hard disk drive (HDD), a solid state disk (SSD), an embedded multimedia card (eMMC), and universal flash storage (UFS).

According to an embodiment, the memory 420 may store some of information included in a memory (e.g., the memory 330 of FIG. 3) of the controller 202.

The communication circuit 430 may establish a wired or wireless communication connection between the terminal 201 and an external electronic device (e.g., the controller 202 or the switch 203 of FIG. 2) and may support communication execution through the established communication connection. According to an embodiment, the communication circuit 430 may include a wireless communication circuit (e.g., a cellular communication circuit, a short-range wireless communication circuit, or a global navigation satellite system (GNSS) communication circuit) or a wired communication module (e.g., a local area network (LAN) communication circuit or a power line communication circuit) and may communicate with the external electronic device by using a corresponding communication circuit among them through the short-range communication network such as a Bluetooth, a WiFi direct, or an infrared data association (IrDA)) or the long-distance communication network such as a cellular network, an Internet, or a computer network. The above-mentioned various communication circuits 430 may be implemented into one chip or may be respectively implemented into separate chips.

The display 440 may visually output content, data, or a signal. In various embodiments, the display 440 may display image data processed by the processor 410. In embodiments, the display 440 may be configured with an integrated touch screen by being coupled with a plurality of touch sensors (not shown) capable of receiving a touch input or the like. When the display 440 is composed of a touch screen, the plurality of touch sensors may be disposed above the display 440 or below the display 440.

In the meantime, according to an embodiment, a server (e.g., the controller 202) may include the processor 410, the memory 420, and the communication circuit 430. The processor 410, the memory 420, and the communication circuit 430 included in the server may be substantially the same as the processor 410, the memory 420, and the communication circuit 430 described above.

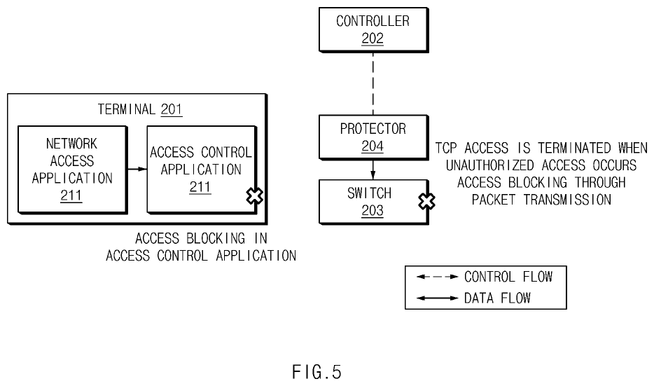

FIG. 5 is a diagram for describing an operation in which network access is blocked, according to various embodiments.

According to an embodiment, when an access application is not connected with the controller 202, TCP session creation in the case of data packets transmitted to the service server 235 is blocked by the protector 204, and thus no data packets other than data packets transmitted to the controller 202 are transmitted to the service server 235.

When the access control application 211 is not connected with the controller 202, TCP session creation in the case of data packets transmitted to the service server 235 is blocked by the protector 204, and thus no data packets other than data packets transmitted to the controller 202 are transmitted to the service server 235.

The access control application 211 needs to access the controller 202 and to identify and authenticate information about the terminal 201, one or more identification information, and an application. When the service server 235 is accessed after authentication is performed, the access control application 211 queries the controller 202 for access network information to determine whether access is possible, and transmits only data packets of the authorized application to a network.

Accordingly, the unauthorized terminal 201 or application may not fundamentally access the service server 235. When data flow information including access information of the corresponding application is not delivered from the controller 202 to the protector 204 even in the case of the authorized terminal 201 or application, TCP session creation is blocked and terminated. Accordingly, the service server 235 is in an unreachable state (i.e., in an isolation state).

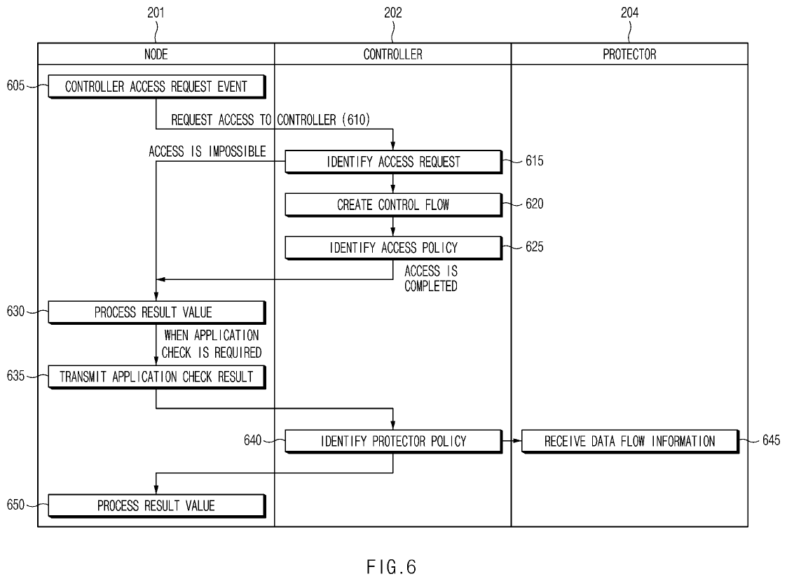

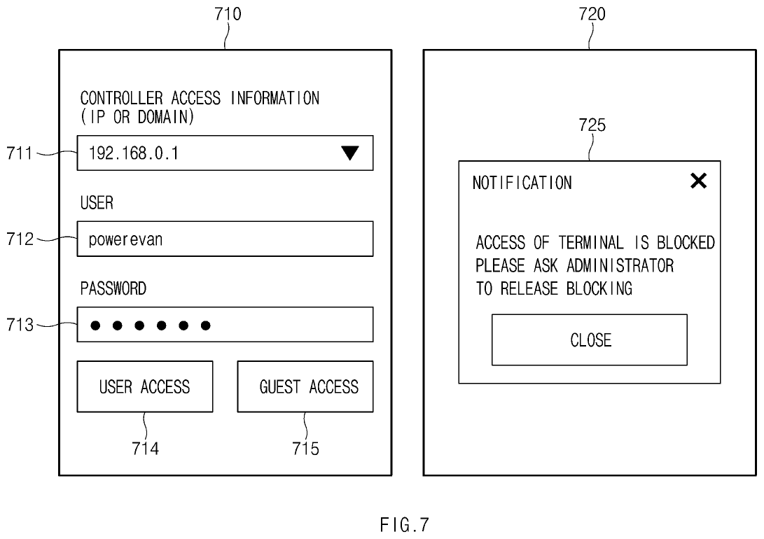

FIGS. 6 and 7 are diagrams for describing operations for controller access, according to various embodiments. FIG. 6 shows a signal flowchart for controller access. FIG. 7 shows a user interface screen for controller access.

For the terminal 201 to access a network or to receive data packets, there is a need to be authorized by the controller 202, and thus the access control application 211 of the terminal 201 may attempt to access a controller of the terminal 201, by requesting the controller 202 to create a control flow (a control data packet flow and a series of sessions). Moreover, the access control application 211 may include the access control application 211 in FIG. 2.

When the access control application 211 is executed for access to the controller 202, a user may enter access information and may click a user access button 714.

The controller 202 may determine whether the terminal 201 is accessible, by determining whether information (the type of the corresponding terminal 201, location information of the corresponding terminal 201, an environment of the corresponding terminal 201, a network in which the terminal 201 is included, or the like) requested by the access control application 211 is accessible according to the policy, and determining whether information about the terminal 201 and network identification information (identification information, IP, or MAC address of the terminal 201) are included in a blacklist. When access is possible, the controller 202 may generate a control flow and may transmit identification information about the generated control flow to the terminal 201.

When the access of the terminal 201 is impossible, the access control application 211 may display an inaccessibility message and the reason on a screen (725).

When the controller 202 is accessed normally, it is determined through the controller 202 whether all network access requests generated afterward from the terminal 201 are approved. User authentication has not been performed at the current stage, and thus access policies corresponding to unidentified users (guests) are applied.

Referring to FIG. 6, in operation 605, the terminal 201 may detect a controller access event. For example, the access control application 211 may request access to the controller 202 to create a control flow (a control data packet flow and a series of sessions) with the controller 202 (operation 610).

As an embodiment of a controller access event, referring to FIG. 7, when the access control application 211 is executed, the terminal 201 may display a user interface screen 710 for receiving information necessary to access a controller. The user interface screen 710 may include an input window 711 for entering an IP or domain of the controller 202, an input window 712 for entering user identification information, an input window 713 for entering a password, and/or an input window 714 for entering an access location. After information about the input windows 711 to 714 are entered, the terminal 201 may detect a controller access event by receiving a button 715 for allowing an authenticated user to access the controller. For another example, when user authentication of the terminal 201 is not yet completed, the terminal 201 may detect the controller access event by receiving a button 716 for allowing an unauthorized user (i.e., a guest) to access the controller.

In operation 615, the controller 202 may determine whether the terminal 201 is accessible, by determining whether information (the type of the corresponding terminal 201, location information of the corresponding terminal 201, an environment of the corresponding terminal 201, a network in which the terminal 201 is included, information about the access control application 211, or the like) requested by the access control application 211 is accessible according to the policy, and determining whether information about the terminal 201 and network identification information (identification information, IP, or MAC address of the terminal 201) are included in a blacklist.

When access is impossible or the information is included in the blacklist, the controller 202 transmits inaccessibility information to the terminal 2011.

In operation 620, when the terminal 201 is accessible, the controller 202 creates a control flow, generates control flow identification information in a form of random numbers, and adds identification information (identification information, IP, or MAC address of the terminal 201) about the terminal 201 and a network to the control flow table by writing the identification information.

In operation 625, according to the access policy matched with the identified information (the terminal 201, source network information, or the like), the controller 202 creates accessible application whitelist information. As the access result, when the access is completed, user authentication of the terminal 201 is requested, and information about the terminal 201 is continuously updated, the controller 202 returns control flow identification information for identifying the control flow and an application whitelist created through the process. When access is not possible, the controller 202 transmits the inaccessibility result to the terminal 201.

In operation 630, the terminal 201 may process an access request result value received from the controller 202. When access is impossible, the terminal 201 may stop and terminate the execution of the access control application 211, and may display a related error message.

In operation 635, when the terminal 201 receives an application whitelist from the controller 202, the terminal 201 determines whether the corresponding application is installed on the terminal 201. When the corresponding application is present, the terminal 201 transmits the results of checking the integrity and safety of the corresponding application (whether an application is forged or tampered, a code signing check, a fingerprint check, or the like) according to the validation check policy to the controller 202.

In operation 640, when access is possible, the controller 202 may identify the protector 204 where the corresponding terminal 201 is located in the policy of the protector 204 to allow access of the terminal 201 connected to the corresponding network, and may determine whether data flow information accessible to the corresponding destination IP and port is present in the data flow table 316.

When there is no valid data flow information in the data flow table 316, the protector 204 may generate data flow information based on source IP, destination IP and port information such that the corresponding application is capable of allowing the creation of a TCP session with the service server 235, and may transmit the data flow information to the identified protector 204 (operation 645).

When there is data flow information accessible in the data flow table 316, the corresponding information may be transmitted to the terminal 201.

In operation 650, the terminal 201 may process an access request result value received from the controller 202.

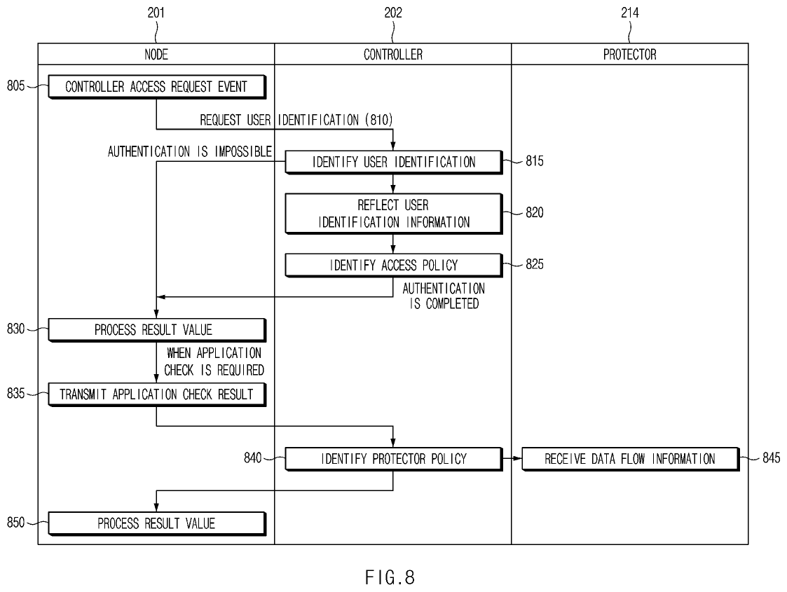

FIG. 8 shows a signal flowchart for user authentication, according to various embodiments.

The controller 202 determines whether a user is blocked, by determining whether the corresponding user is authenticated and is included in a blacklist, based on information (user identification information and a password, enhanced authentication information, or the like) requested for authentication by the access control application 211. When the user is authenticated, the controller 202 completes the authentication process and adds the user identification information to a control flow.

When the user authentication fails, the access control application 211 displays an inaccessibility message and the reason on a screen.

When the user is successfully authenticated, an access policy corresponding to the authenticated user is applied to determine whether network access is authorized.

Referring to FIG. 8, in operation 805, the access control application 211 may perform user authentication to receive detailed access permissions of a network. The access control application 211 may transmit user identification information and a password or authentication information by enhanced authentication method to the controller 202 (operation 810).

In operation 815, the controller 202 determines whether the user is blocked, by determining whether a user is authenticated and is included in the blacklist, based on information (user identification information and a password, enhanced authentication information, or the like) requested for authentication by the access control application 211.

When authentication is impossible, the controller 202 transmits inaccessibility information when access to the terminal 201 is impossible or the user is included in the blacklist.

In operation 820, when the user is authenticated, the controller 202 may search for a control flow in a control flow table by using the transmitted control flow identification information, and may add user identification information to the identification information in the found control flow. The controller 202 may return an authentication completion state and access policy information of the authenticated user as the result of user authentication.

In operation 825, according to the access policy matched with the identified information (the terminal 201, source network information, user identification information, or the like), the controller 202 creates accessible application whitelist information. As the access result, when the access is completed, user authentication of the terminal 201 is requested, and information about the terminal 201 is continuously updated, the controller 202 returns control flow identification information for identifying the control flow and an application whitelist created through the process.

When access is not possible, the controller 202 transmits the inaccessibility result to the terminal 201.

In operation 830, the terminal 201 may process an access request result value received from the controller 202. When access is impossible, the terminal 201 may stop and terminate the execution of the access control application 211, and may display a related error message through a user interface.

In operation 835, when the terminal 201 receives an application whitelist from the controller 202, the terminal 201 may determine whether the corresponding application is installed on the terminal 201. When the corresponding application is present, the terminal 201 may transmit the results of checking the integrity and safety of the corresponding application (whether an application is forged or tampered, a code signing check, a fingerprint check, or the like) according to the validation check policy to the controller 202.

In operation 840, when access is possible, the controller 202 may identify the protector 204 where the corresponding terminal 201 is located in the policy of the protector 204 to allow access of the terminal 201 connected to the corresponding network, and may determine whether data flow information accessible to the corresponding destination IP and port is present in the data flow table 316.

When there is no valid data flow information in the data flow table 316, the protector 204 may generate data flow information based on source IP, destination IP and port information such that the corresponding application is capable of allowing the creation of a TCP session with the service server 235, and may transmit the data flow information to the identified protector 204 (operation 845).

When there is data flow information accessible in the data flow table 316, the corresponding information may be transmitted to the terminal 201.

In operation 850, the terminal 201 may process an access request result value received from the controller 202.

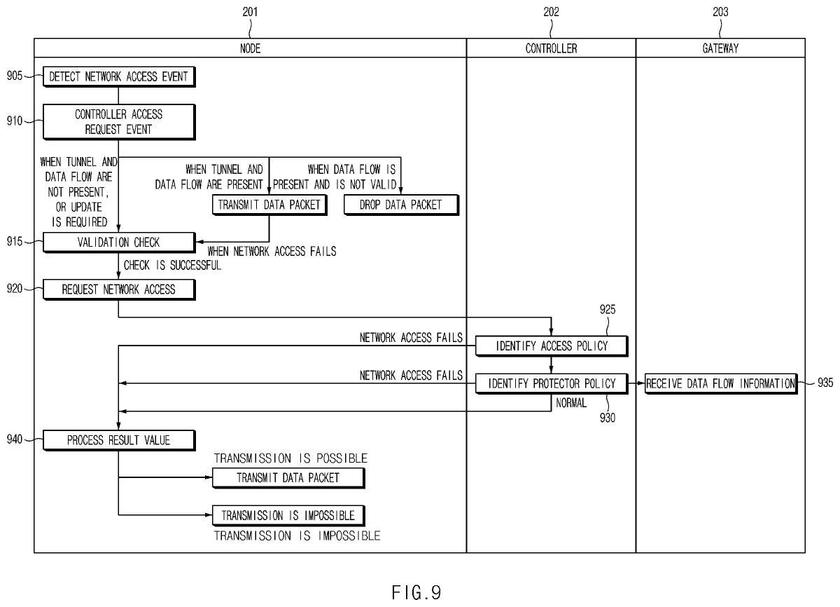

FIG. 9 illustrates a flowchart of a signal for processing network access.

When there is a network access request, the access control application 211 identifies an application requested for access, destination IP, and service port information, and determines whether there is valid data flow information capable of being used as the corresponding identification information in the data flow table 316.

The data flow table 316 may provide information for determining whether data packets are capable of being transmitted for each access and management unit.

When there is available data flow information, data packets may be transmitted.

When there is no data flow information, a validation check procedure is performed according to the validation check policy. The validation check may be performed to determine in advance whether the access control application 211, access target IP, and port are accessible, based on the check of the integrity and safety (whether an application is forged or tampered, a code signing check, a fingerprint check, or the like) of the application requested for access and the access policy received from the controller 202.

When the validation check fails, data packets may be dropped, and an inaccessibility message and the reason may be displayed in the access control application 211.

When the validation check is successful, the terminal 201 may make an access request to the controller 202 and may transmit respective identification information (the access control application 211, access target IP, service port information, or the like) upon request.

The controller 202 may determine whether the identification information (the access control application 211, access target IP, service port information, and the like) requested for access is included in the access policy matched with information (the terminal 201, a user, source network information, or the like) identified on the control flow, and whether the access is possible.

When access is impossible, the controller 202 may transmit an inaccessibility result to the terminal 201, may drop the corresponding data packet, and may display an inaccessibility message and the reason.

When the access is possible, data flow information including information for unblocking the corresponding data packet is transmitted to the protector 204 placed between the service server 235 and an application.

The access control application 211 identifies an access request result value received from the controller 202.

The access control application 211 receiving data flow information transmits data packets to the service server 235. The protector 204 placed between the application and the service server 235 determines whether a valid data flow is included in the received data packet based on the corresponding authentication data packet, source IP, destination IP, and a port. When the data flow is invalid, the protector 204 transmits a TCP session termination data packet (e.g., RST) to the terminal 201.

Through this procedure, the application is fundamentally blocked from the service server 235. An environment is provided such that only data packets included in the data flow table 316 permitted through the authorization process of the controller 202 and the TCP session monitoring process of the protector 204 are capable of being transmitted.

Referring to FIG. 9, in operation 905, the access control application 211 may detect a network access event. For example, the access control application 211 may detect that a target application such as a web browser attempts to access a destination network including the destination network 230 such as the Internet. For example, a user may launch the web browser and may enter and call a web address to be accessed.

In operation 910, when the access control application 211 needs to communicate with the service server 235, the access control application 211 may determine whether data flow information is present, based on application identification information, destination IP, and port information to communicate with the service server 235. When a data flow is invalid (e.g., the transmission of a data packet is impossible) although the data flow is present, the data packet may be dropped. When the data flow is present, the data packet may be transmitted.

In operation 915, when an update is required because there is no data packet or the authentication time has expired, and a data flow needs to be updated due to other reasons, the validation check procedure may be performed according to the validation check policy. The validation check may include checking the integrity and safety (whether an application is forged or tampered, a code signing check, a fingerprint check, or the like) of the access control application 211.

In operation 920, the access control application 211 may make a network access request to the controller 202 based on control flow identification information and application identification information for identifying a control flow created with the controller 202 prior to a network access event, and destination IP and port information of a server to be accessed.

In operation 925, the controller 202 may determine whether the identification information (an application, destination IP, and service port information) requested for access is included in the access policy matched with information (the terminal 201, a user, source network information, or the like) identified on the control flow, and whether access to a destination server mapped with the corresponding identification information is possible. When the access is impossible, the controller 202 may transmit the inaccessibility result to the terminal 201.

In operation 930, when access is possible, the controller 202 may identify the protector 204 where the corresponding terminal 201 is located in the policy of the protector 204 to allow access of the terminal 201 connected to the corresponding network, and may determine whether data flow information accessible to the corresponding destination IP and port is present in the data flow table 316.

When there is no valid data flow information in the data flow table 316, the protector 204 may generate data flow information based on source IP, destination IP and port information such that the corresponding application is capable of allowing the creation of a TCP session with the service server 235, and may transmit the data flow information to the identified protector 204 (operation 935).

When there is data flow information accessible in the data flow table 316, the corresponding information may be transmitted to the terminal 201.

In operation 940, the access control application 211 may process the access request result received from the controller 202. When the network access fails, data packets may be dropped. When the access is possible based on the existing data flow, data packets may be transmitted.

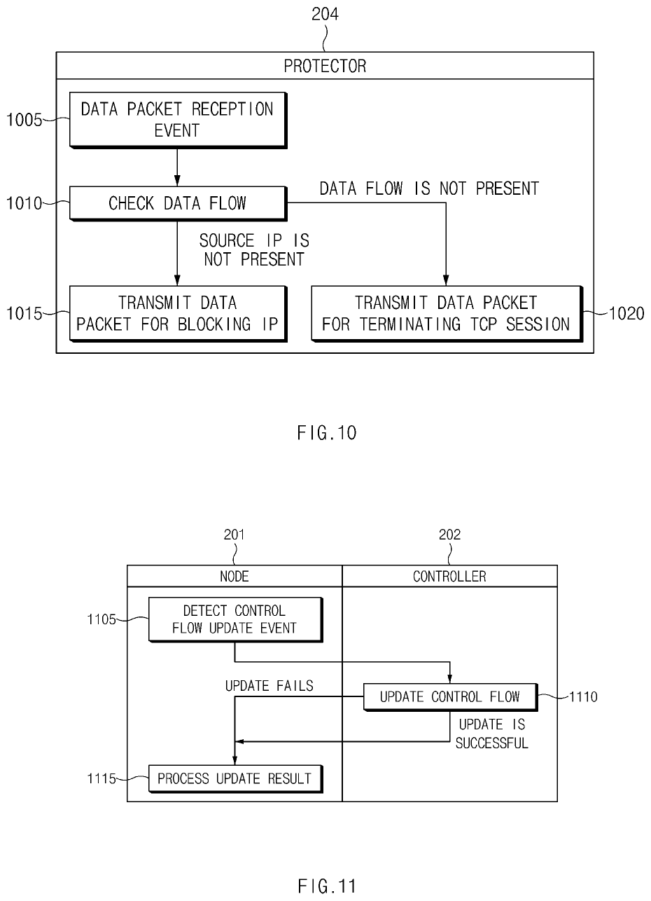

FIG. 10 shows a signal flowchart for blocking network access, according to various embodiments.

In operation 1005, the protector 204 may receive multicast data packets existing in the same segment as the terminal 201 through the switch 203.

In operation 1005, when the protector 204 receives a data packet, the protector 204 may determine whether a data flow corresponding to the received source IP is present in the data flow table 316, based on source IP, destination IP, and destination port information included in the 5-tuple information of Internet protocol (IP).

In operation 1010, when there is no data flow corresponding to the source IP in the data flow table 316, the protector 204 may transmit IP blocking data packets (ARP Spoofing), and may record data packet transmission blocking logs (operation 1015).

When the source IP is present in the data flow table 316, the protector 204 may determine whether data flow information corresponding to the destination IP and destination port is present.

In operation 1020, when there is no data flow, the protector 204 may transmit a TCP data packet (e.g., RST packet) for forcibly terminating a TCP session, and may record data packet transmission blocking logs.

FIG. 11 shows a flowchart for updating a control flow, according to various embodiments.

In operation 1105, an application may maintain information about a control flow and a data flow currently accessed, and may make a request for updating the control flow based on control flow identification information periodically received to receive updated data flow from the controller 202.

In operation 1110, the controller 202 may determine whether the control flow is present in a control flow table, based on the control flow identification information requested by the terminal 201.

When there is no control flow (e.g., access release by another security system, expiring an update time, access release by internal risk detection, or the like), the access of the terminal 201 may be invalid, and thus inaccessibility information may be may returned.

When the control flow is present, the update time may be updated, and data flow information dependent on the corresponding control flow may be found.

When authentication needs to be again performed on a data flow, or there is a data flow incapable of being accessed, the corresponding data flow information may be returned.

In operation 1115, when the control flow update result is impossible, the application may be terminated, or all network access of the application may be blocked.

When the control flow update result is normal, and there is updated data flow information, information of the data flow table 316 within the application may be updated.

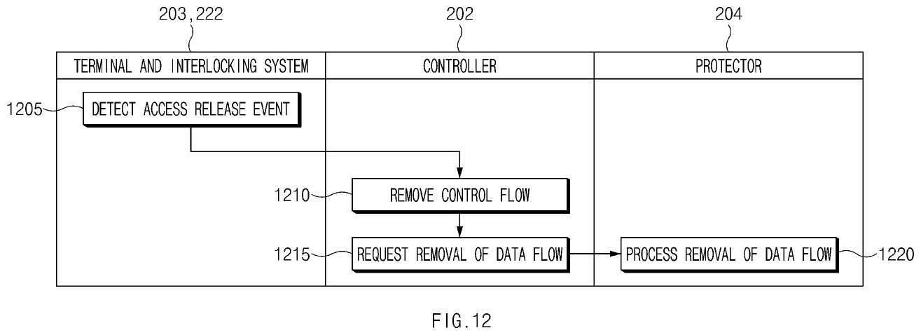

FIG. 12 illustrates a flowchart for releasing network access, according to various embodiments.

In operation 1205, when the application is terminated or the application no longer uses network access, a control flow termination request may be made to the controller 202, when an access termination request is made based on information identified from an interlocking system.

In operation 1210, the controller 202 may remove the control flow identified and found based on the control flow identification information requested by the terminal 201.

In operation 1215, when the control flow is removed, the protector 204 relaying all dependent data flows may be requested to remove the data flow.

In operation 1220, because the data flow is removed by the protector 204, the corresponding application may no longer transmit data packets to a destination network.

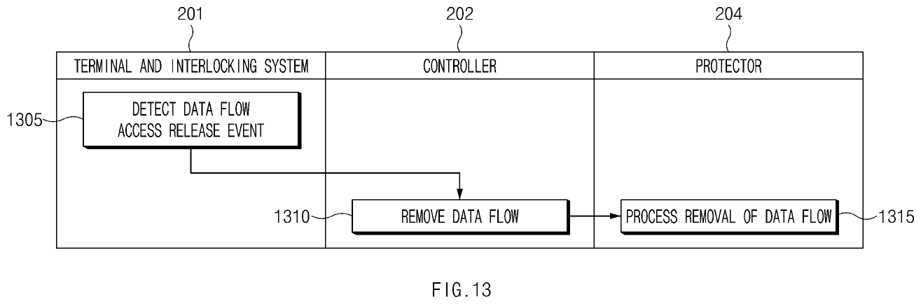

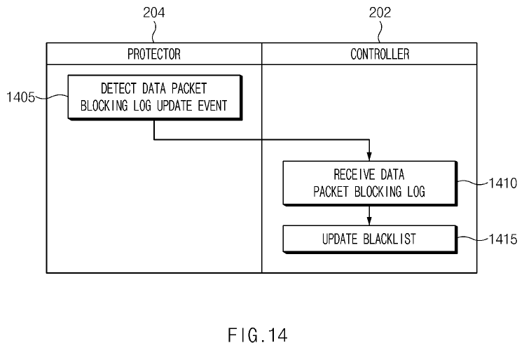

FIG. 13 shows a flowchart for releasing unit network access, according to various embodiments.

In operation 1305, when an application no longer needs access to the specific service server 235, and an access termination request occurs based on information identified from an interlocking system, a data flow termination request may be made to the controller 202.

In operation 1310, the controller 202 may remove a data flow dependent on the control flow identified and found based on the control flow identification information and data flow identification information requested by the terminal 201.

In operation 1315, the application may no longer transmit data packets to a destination network by requesting removal of the data flow from the protector 204 relaying the corresponding data flow.

FIG. 14 shows a flowchart for synchronization of data packet blocking logs, according to various embodiments.

In operation 1405, the protector 204 may periodically transmit data packet blocking logs collected according to a procedure of IP blocking or forcedly terminating a TCP session to the controller 202.

In operation 1410, the controller 202 may receive the data packet blocking logs from the protector 204. When unauthorized access is periodically performed by the blacklist policy stored in the blacklist policy database 313 based on the blocked source IP address, destination IP address, and port information included in the data packet blocking logs received from the protector 204, in operation 1415, the controller 202 may add the corresponding source IP address to the blacklist such that access to the corresponding source IP is temporarily or permanently impossible, or may update relevant information when the corresponding source IP is included in the existing blacklist (the blacklist database 314).

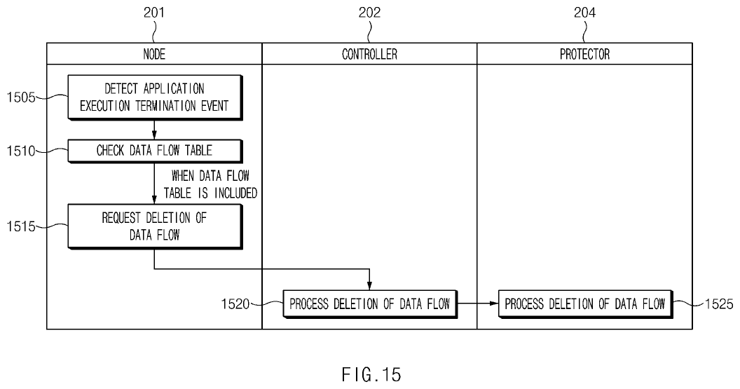

FIG. 15 shows a flowchart for terminating application execution, according to various embodiments.

In operation 1505, an access control application may determine in real time whether an application running on a terminal is terminated. When the application is terminated, the access control application may perform a procedure of checking the data flow table 316.

In operation 1510, whether identification information and process ID and child process ID Tree (PID) information of the terminated application are present in a data flow table.

In operation 1515, when the identification information and PID of the terminated application are present in the data flow table, the deletion of the data flow may be requested.

When the terminated application is not present in the running process list to track the termination of multiple executable applications, the deletion of all data flows corresponding to the identification information of the terminated application may be requested.

The access control application 211 may request the deletion of the data flow by transmitting the deleted data flow list to the controller 202.

In operation 1520, the controller 202 may delete the corresponding data flow from the data flow table 316 based on the deleted data flow list received from a terminal, and may transmit the deleted data flow list to the protector.

In operation 1525, the protector 204 may process data packets corresponding to the source IP address, destination IP address, and destination port information included in the deleted data flow list to no longer be forwarded.

Hereinabove, the above description is merely illustrative of the technical idea disclosed in the specification, and various modifications and variations may be made by one skilled in the art, to which the embodiments disclosed in the specification belong, without departing from the essential characteristic of the embodiments disclosed in the specification.

Therefore, embodiments disclosed in the specification are intended not to limit but to explain the technical idea disclosed in the specification, and the scope of the technical idea disclosed in the specification is not limited by this embodiment. The scope of protection disclosed in the specification should be construed by the attached claims, and all equivalents thereof should be construed as being included within the scope of the specification.

1. A network node comprising:
a communication circuit;
a memory; and
a processor operatively connected to the communication circuit and the memory, wherein the processor is configured to:
receive, from a server, a data flow including a node IP, a destination network IP, and port information, which are created to allow creation of a TCP session between a source node and a destination network;
monitor a data packet broadcast or multicast from the source node through a switch of a network to which the source node belongs;
transmit an IP blocking data packet to the source node when there is no data flow corresponding to a source IP of the data packet received through the monitoring; or
transmit a TCP data packet for forcibly terminating a TCP session to the source node when there is no data flow corresponding to a destination IP and destination port information of the data packet received through the monitoring, and
wherein the network node is connected to the switch.

2. The network node of claim 1, wherein the processor is configured to:
prevent an access control application of the source node from transmitting a data packet to a destination network by removing a data flow, when a data flow removal request is received from the server.

3. The network node of claim 1, wherein the processor is configured to:
transmit a collected data packet blocking log to the server at regular intervals in response to detecting a data packet blocking log update event for data packet blocking log synchronization.

4. The network node of claim 3, wherein the data packet blocking log update event includes IP blocking or forcedly terminating the TCP session, and
wherein the data packet blocking log includes a node IP address, a destination IP address, and port information, which are blocked.

5. A server comprising:
a communication circuit;
a memory configured to store a database; and
a processor operatively connected to the communication circuit and the memory, wherein the processor is configured to:
receive a request for network access from an access control application of a source node;
determine whether identification information including an application, a destination network IP, and service port information are included in an access policy matched with information identified on a control flow including the source node, a user, and network information of the source node, and whether access to a destination network mapped with the identification information is possible;
identify a network node where the source node is located in a network node policy to allow access of the source node, when access is possible;
determine whether data flow information accessible by using the destination network IP and the service port information is present in a data flow table;
create data flow information based on an IP of the source node, the destination network IP, and the service port information such that the application is capable of creating a TCP session with the destination network, when there is no valid data flow information in the data flow table, and transmit the created data flow information to the source node and the identified network node;
transmit the data flow information to the source node when the accessible data flow information is present in the data flow table;
receive a data packet blocking log from the network node; and
update a blacklist based on the data packet blocking log and a blacklist policy included in the database.

6. The server of claim 5, wherein the processor is configured to:
receive a request for user authentication from the access control application of the source node;
determine whether the user is blocked, by checking whether the user is accessible, based on information requested for authentication by the access control application, and whether the user is included in a blacklist;
search for a control flow in a control flow table by using control flow identification information when the user is identified to being the accessible user, and add user identification information to identification information in the found control flow; and
return an authentication completion state and access policy information of an authenticated user to the source node as a result of user authentication.

7. The server of claim 6, wherein the processor is configured to:
create accessible application whitelist information in an access policy matched with the identified information;
return an access completion status as an access result; and
return control flow identification information for identifying a control flow, and the created application whitelist, when an additional user authentication request of the source node or a continuous terminal information update request is received.

8. The server of claim 6, wherein the processor is configured to:
receive a control flow update request from the source node;
determine whether a control flow is present in the control flow table, based on control flow identification information requested by the source node in response to the control flow update request;
return inaccessibility information indicating that access of the source node is invalid, to the source node when there is no control flow for the source node in the control flow table;
update an update time when there is a control flow for the source node in the control flow table, and search for data flow information dependent on the control flow;
return data flow information to the source node when authentication needs to be again performed on a data flow for the source node or there is a data flow incapable of being accessed; and
update information of the data flow table when a control flow update result is normal, and there is updated data flow information.

9. The server of claim 8, wherein the processor is configured to:
receive a control flow termination request from the source node;
remove a control flow identified and found based on control flow identification information, which is requested by the source node, in response to a control flow termination request; and
transmit a data flow removal request to the network node and request removal when the control flow is removed, and
wherein the network node prevents the access control application from transmitting a data packet to a destination network by removing a data flow in response to the data flow removal request.

10. An operating method of a network node, the method comprising:
receiving, from a server, a data flow including a node IP, a destination network IP, and port information, which are created to allow creation of a TCP session between a source node and a destination network;
monitoring a data packet broadcast or multicast from the source node through a switch of a network to which the source node belongs;
transmitting an IP blocking data packet to the source node when there is no data flow corresponding to a source IP of the data packet received through the monitoring; and
transmitting a TCP data packet for forcibly terminating a TCP session to the source node when there is no data flow corresponding to a destination IP and destination port information of the data packet received through the monitoring, and
wherein the network node is connected to the switch.
